(19) United States
(12) Patent Application Publication
(10) Pub. No.: US 2009/0327770 A1
(43) Pub. Date: Dec. 31, 2009

(54) POWER SUPPLY SYSTEM AND POWER SUPPLYING CONTROL METHOD

(75) Inventors: Chih-Wei Lin, Taipei (TW); Chih-Wan Hsu, Taipei (TW); Nung-Te Huang, Taipei (TW)

Correspondence Address: KIRTON AND MCCONKIE, 60 EAST SOUTH TEMPLE,, SUITE 1800, SALT LAKE CITY, UT, 84111, US

(73) Assignee: ASUSTEK COMPUTER INC., Taipei (TW)

(21) Appl. No.: 12/473,331

(22) Filed: May 28, 2009

(30) Foreign Application Priority Data
Jun. 30, 2008 (TW) 097124590

(51) Int. Cl. G06F 1/26

(52) U.S. Cl. 713/300

(57) ABSTRACT

A power supply system adopting two power supplies connected in parallel includes a first power supply comprising a first voltage-output terminal; a second power supply comprising a second voltage-output terminal; a first switch circuit comprising an input terminal connected to the first voltage-output terminal; a second switch circuit comprising an input terminal connected to the second voltage-output terminal; and a plug comprising a first pin connected to both an output terminal of the first switch circuit and an output terminal of the second switch circuit; wherein the voltage outputted from the first voltage-output terminal is equal to the voltage outputted from the second voltage-output terminal.

### FIELD OF THE INVENTION

The present invention relates to a power supply system, and more particularly to a power supply system having two power supplies connected in parallel. The present invention also relates to a power supplying control method of a power supply system having two power supplies connected in parallel.

### BACKGROUND OF THE INVENTION

The main function of a power supply arranged in a computer is firstly converting an AC power to a DC power, and then providing the DC power to a motherboard or other peripheral devices. Referring to FIG. 1, a conventional power supply system providing specific voltages to a motherboard is shown. The system comprises a power supply 80 and a motherboard 90. According to specification of the computer power supply system, the power supply 80 further comprises 24 pins, 4 pins, VGA pins, and HD pins. The 24 pins, the 4 pins, the VGA pins, and the HD pins are connected to a 24-pin plug 82, a 4-pin plug 84, a VGA plug 86, and a HD plug 88, respectively. The motherboard 90 further comprises a 24-pin jack 92, a 4-pin jack 94, a VGA jack 96, and a HD jack 98; where the 24-pin jack 92, the 4-pin jack 94, the VGA jack 96, and the HD jack 98 are corresponding to the 24-pin plug 82, the 4-pin plug 84, the VGA plug 86, and the HD plug 88, respectively. After the connected between the plugs of the power supply 80 and the corresponding jacks of the motherboard 90, the specific voltages (+3V, +5V, +5VSB (Stand-By-Power), and +12V) can be transmitted from the power supply 80 to the motherboard 90.

However, because user may not switch off the AC power of the power supply after the shutdown of the computer, the Stand-By-Power (e.g., +5VSB) is kept providing to the motherboard. In other words, the Stand-By-Power (e.g., +5VSB) is always outputted from the power supply 80 to the motherboard 90 if the computer system is off but the AC power is connected to the power supply 80. After a long-term period, the circuit related to the Stand-By-Power in the power supply 80 accordingly may be easier damaged than other circuit parts in the power supply 80. Once a portion of the power supply 80 is damaged, the computer system cannot be power on successfully.

### SUMMARY OF THE INVENTION

Therefore, the present invention relates to a power supply system having two power supplies connected in parallel.

The present invention provides a power supply system adopting two power supplies connected in parallel, comprising: a first power supply comprising a first voltage-output terminal; a second power supply comprising a second voltage-output terminal; a first switch circuit comprising an input terminal connected to the first voltage-output terminal; a second switch circuit comprising an input terminal connected to the second voltage-output terminal; and, a plug comprising a first pin connected to both an output terminal of the first switch circuit and an output terminal of the second switch circuit; wherein the voltage outputted from the first voltage-output terminal is equal to the voltage outputted from the second voltage-output terminal.

The present invention provides a computer with a power supply system adopting two power supplies connected in parallel, comprising: a first power supply comprising a first voltage-output terminal; a second power supply comprising a second voltage-output terminal; a first switch circuit comprising an input terminal connected to the first voltage-output terminal; a second switch circuit comprising an input terminal connected to the second voltage-output terminal; a plug comprising a first pin connected to both an output terminal of the first switch circuit and an output terminal of the second switch circuit; and, a motherboard comprising a jack disposed therein a first pin connected to the first pin of the plug; wherein the voltage outputted from the first voltage-output terminal is equal to the voltage outputted from the second voltage-output terminal.

The present invention provides a power supplying control method of a computer system for use with a first power supply and a second power supply both providing a first voltage to a motherboard, comprising steps of: detecting whether the first power supply starts to build the first voltage; outputting the first voltage, built by the first power supply, to a first pin when the first power supply starts to build the first voltage; detecting whether the second power supply starts to build the first voltage; outputting the first voltage, built by the second power supply, to the first pin when the second power supply starts to build the first voltage; and, outputting the first voltage power to the motherboard via the first pin.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 schematically illustrating a conventional power supply system providing specific voltages to a motherboard;

FIG. 2 is a functional block diagram illustrating a power supply system adopting two power supplies connected in parallel of the present invention;

FIG. 3 is a functional block diagram illustrating the power translating board adopted in the present invention;

FIG. 4 schematically illustrating the switch circuit adopted in the present invention;

FIG. 5 is a block diagram illustrating the switch circuit adopted in the present invention; and

FIG. 6 a flowchart illustrating the operating steps of the present invention.

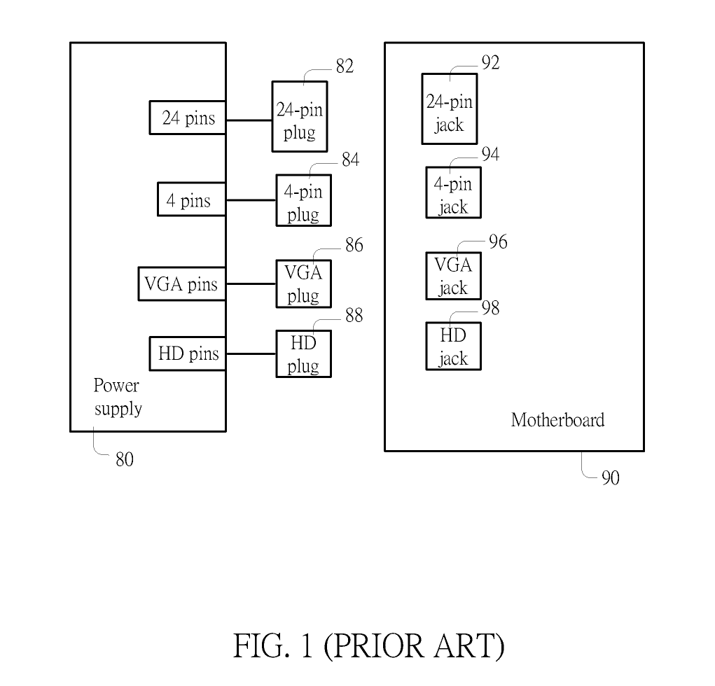

### DETAILED DESCRIPTION OF PREFERRED EMBODIMENTS

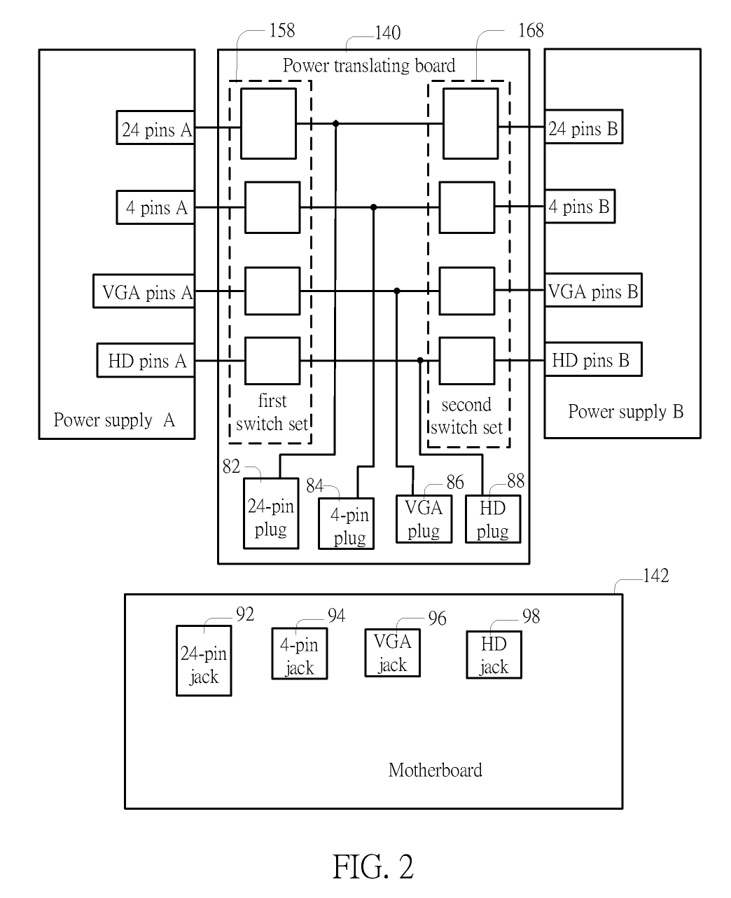

Referring to FIG. 2, a power supply system adopting two power supplies constructed in parallel of the present invention providing specific voltages to a motherboard is shown. The power supply system of the present invention, connected to a motherboard 142, comprises a power supply A, a power supply B, and a power translating board 140, where the power supply A comprises a pin set (24 pins A, 4 pins A, VGA pins A, HD pins A) for outputting the specific voltages (+3V, +5V, +5VSB, +12V), the power supply B also comprises a pin set (24 pins B, 4 pins B, VGA pins B, HD pins B) for outputting the specific voltages (+3V, +5V, +5VSB, +12V).

Moreover, the pin set of the power supply A (24 pins A, 4 pins A, VGA pins A, HD pins A) are connected to a first switch set 158 arranged on the power translating board 140. The pin set of the power supply B (24 pins B, 4 pins B, VGA pins B, HD pins B) are connected to a second switch set 168 on the power translating board 140. Moreover, the parallel connection of the power supply A and the power supply B is achieved via connecting the switches in the first switch set 158 and the corresponding switches in the second switch set 168. Moreover, because of the parallel connection of the power supply A and the power supply B, the 24 pins A and the 24 pins B are together connected to the 24-pin plug 82; the 4 pins A and the 4 pins B are together connected to the 4-pin plug 84; the VGA pins A and the VGA pins B are together connected to the VGA plug 86; and the HD pins A and the HD pins B are together connected to the HD plug 88. As mentioned above, the jack set of the motherboard 142 (24-pin jack 92, 4-pin jack 94, VGA jack 96, HD jack 98) are respectively connected to the plug set of the power translating board 140 (24-pin plug 82, 4-pin plug 84, VGA plug 86, HD plug 88).

Before the motherboard 142 is active, only the Stand-By-Power (e.g., +5VSB) is provided from the power supplies A and B to the motherboard 142. After the motherboard 142 is active resulted from the power button of the computer is pressed, the power supplies A and B are automatically activated by the motherboard 142, and the specific voltages (+3V, +5V, and +12V), demanded of the motherboard 142, are started to be built by the power supplies A and B and then outputted to the motherboard 142 via a plurality of voltage-output terminal in the pin set of the power supplies A and B. That is, the specific voltages (+3V, +5V, and +12V) built by the power supply A, are firstly outputted from the pin set of the power supply A, and then transmitted to the motherboard 142 via the power translating board 140. Similarly, the specific voltages (+3V, +5V, and +12V) built from the power supply B, are firstly outputted from the pin set of the power supply B, and then transmitted to the motherboard 142 via the power translating board 140. Because the power supplies A and B are connected in parallel, the motherboard 142 can get the specific voltages (+3V, +5V, and +12V) via the power translating board 140 if either one of the power supplies A and B is successfully active and starts to build the specific voltages (+3V, +5V, and +12V).

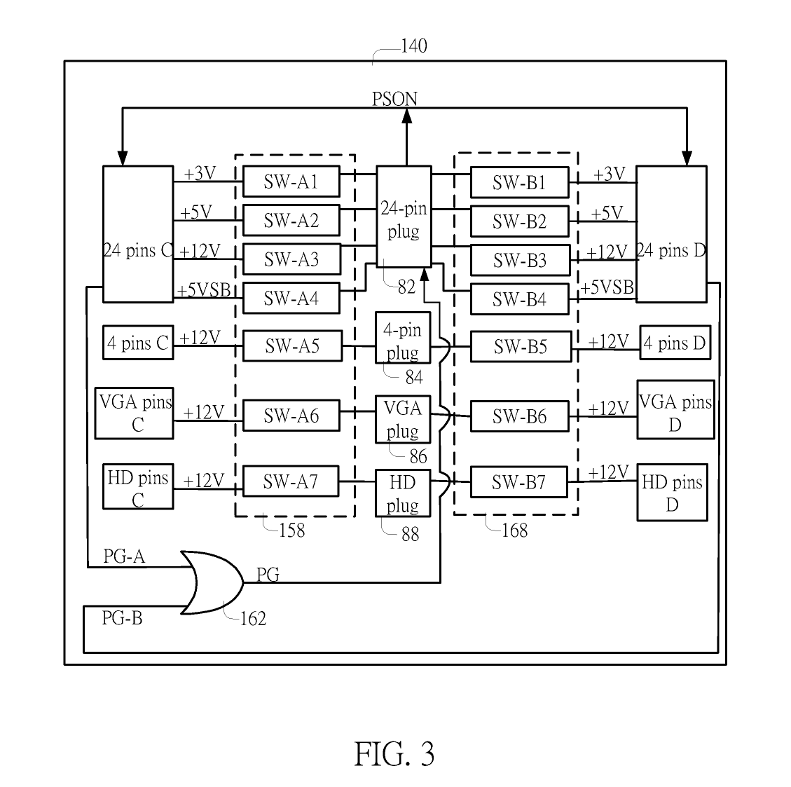

Referring to FIG. 3, a block diagram of the power translating board adopted in the power supply system of the present invention is shown. The power translating board 140 further comprises two pin sets, where the pin set arranged near the power supply A side (24 pins C, 4 pins C, VGA pins C, HD pins C) are connected to the pin set of the power supply A (24 pins A, 4 pins A, VGA pins A, HD pins A), respectively; the pin set arranged near the power supply B side (24 pins D, 4 pins D, VGA pins D, HD pins D) are connected to the pin set of the power supply B (24 pins B, 4 pins B, VGA pins B, HD pins B), respectively.

Moreover, the first switch set 158 comprises 7 switch circuits (SW-A1, SW-A2, SW-A3, SW-A4, SW-A5, SW-A6, SW-A7); the second switch set 168 comprises 7 switch circuits (SW-B1, SW-B2, SW-B3, SW-B4, SW-B5, SW-B6, SW-B7). Moreover, a +3V-output terminal (for outputting +3V) in the 24 pins C is connected to the 24-pin plug 82 via the switch circuit SW-A1; a +5V-output terminal (for outputting +5V) in the 24 pins C is connected to the 24-pin plug 82 via the switch circuit SW-A2; a +12V-output terminal (for outputting +12V) in the 24 pins C is connected to the 24-pin plug 82 via the switch circuit SW-A3; a +5VSB-output terminal (for outputting a Stand-By-Power of +5VSB) in the 24 pins C is connected to the 24-pin plug 82 via the switch circuit SW-A4; the +12V-output terminal in the 4 pins C is connected to the 4-pin plug 84 via the switch circuit SW-A5; the +12V-output terminal in the VGA pins C is connected to the VGA plug 86 via the switch circuit SW-A6; and the +12V-output terminal in the HD pins C is connected to the HD plug 88 via the switch circuit SW-A7.

Similarly, the +3V-output terminal in the 24 pins D is connected to the 24-pin plug 82 via the switch circuit SW-B1; the +5V-output terminal in the 24 pins D is connected to the 24-pin plug 82 via the switch circuit SW-B2; the +12V-output terminal in the 24 pins D is connected to the 24-pin plug 82 via the switch circuit SW-B3; the +5VSB-output terminal in the 24 pins D is connected to the 24-pin plug 82 via the switch circuit SW-B4; the +12V-output terminal in the 4 pins D is connected to the 4-pin plug 84 via the switch circuit SW-B5; the +12V-output terminal in the VGA pins D is connected to the VGA plug 86 via the switch circuit SW-B6; and the +12V-output terminal in the HD pins D is connected to the HD plug 88 via the switch circuit SW-B7.

When the motherboard 142 (FIG. 2) is active resulted from the power button of the computer is pressed, a PSON signal (Power Switch On) is outputted from the 24-pin jack 92 of the motherboard 142. The PSON signal is then transmitted to the power supply A sequentially via the 24-pin plug 82 and the 24 pins C (FIG. 3). Similarly, the PSON signal is also transmitted to the power supply B sequentially via the 24-pin plug 82 and the 24 pins D. After the PSON signal is transmitted to the power supply A or B, the power supply A or B is accordingly activated by the motherboard 142 and starts to build the specific voltages (+3V, +5V, and +12V). After all the specific voltages (+3V, +5V, and +12V) are built by power supply A, the power supply A is at a stable state and a Power Good Signal (PG-A) is then outputted from the power supply A to the 24 pins C. Similarly, after all the specific voltages (+3V, +5V, and +12V) are built by power supply B, the power supply B is at a stable state and a Power Good Signal (PG-B) is then outputted from the power supply B to the 24 pins D. In other words, the Power Good Signal of the power supply A (PG-A) is outputted from the power supply A when the power supply A is at the stable state and the Power Good Signal of the power supply B (PG-B) is outputted from the power supply B when the power supply B is at the stable state.

In the embodiment of the present invention, an OR gate 162 is arranged on the power translating board 140, where the Power Good Signal (PG-A) and the Power Good Signal (PG-B) are transmitted to two input terminals of an OR gate 162 and an output terminal of the OR gate 162 is connected to the 24-pin plug 82. Because the function of the OR gate 162, the Power Good Signal (PG) will be outputted from the output terminal of the OR gate 162 and then further transmitted to the motherboard 142 sequentially via the 24-pin plug 82 and the 24-pin jack 92 if only either one of the power supplies A and B is at the stable state. In other words, the power supply system of the present invention is at a stable state if one of the two power supplies A and B is at the stable state, and the motherboard 142 can be aware of whether the power supply system (constructed by the power supplies A and B) is at stable state based on the Power Good Signal (PG). Moreover, it is understood the OR gate 162 can be replaced by an AND gate, and accordingly the Power Good Signal (PG) is outputted from the output terminal of the AND gate and then further transmitted to the motherboard 142 if both the power supplies A and B are at the stable state.

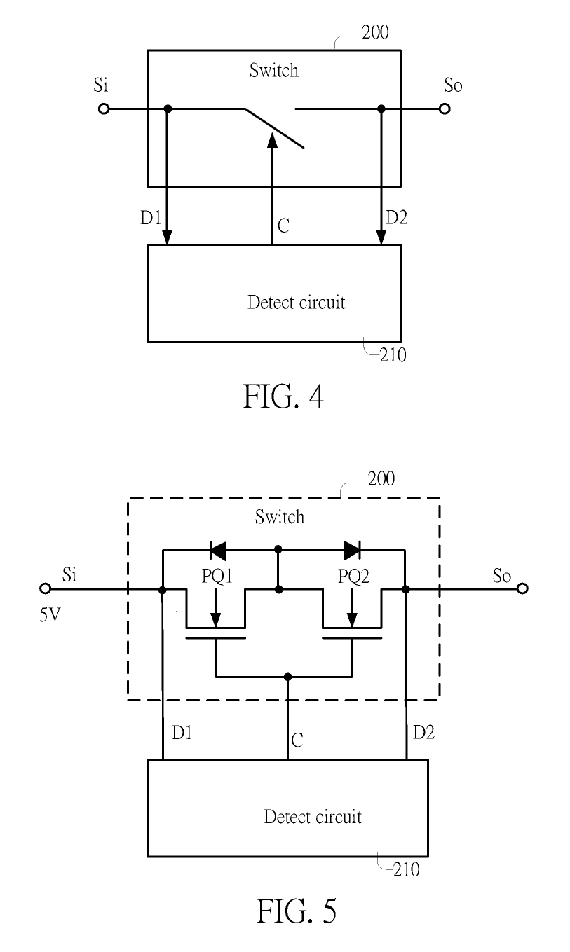

Referring to FIG. 4, a scheme of the switch circuit adopted in the present invention is shown, where all the switch circuits (SW-A1, SW-A2, SW-A3, SW-A4, SW-A5, SW-A6, SW-A7, SW-B1, SW-B2, SW-B3, SW-B4, SW-B5, SW-B6, SW-B7) in the embodiment of the present invention have a same circuit design. The switch circuit comprises a switch 200 and a detect circuit 210. The connection or disconnection between an input terminal (Si) and an output terminal (So) of the switch 200 is controlled by a control signal (C) which is outputted from the detect circuit 210. The detect circuit 210 further comprises two detect terminals (D1, D2) which are connected to the input terminal (Si) and the output terminal (So) of the switch 200, respectively. The control signal (C) with a first level, for the connection of the switch 200, is outputted from the detect circuit 210 if the voltage at the detect terminal (D1) is greater than the voltage at the detect terminal (D2). On the other hand, the control signal (C) with a second level, for the disconnection of the switch 200, is outputted from the detect circuit 210 if the voltage at the detect terminal (D1) is not greater than the voltage at the detect terminal (D2). Moreover, the input terminal (Si) of the switch 200 is connected to the corresponding pin at the power supply side (power supplies A or B); and the output terminal (So) of the switch 200 is connected to the corresponding pin at the plug side.

Referring to FIG. 5, a circuit diagram of the switch circuit adopted in the present invention is shown. The switch 200 is constructed by two MOSFETs (PQ1, PQ2), where the two MOSFETs (PQ1, PQ2) have a back-to-back structure which means both the Bodies of the two MOSFETs (PQ1, PQ2) are attached together. Because the back-to-back structure, a Body Diode is formed in the internal of the two MOSFETs (PQ1, PQ2) and the Body Diode can prevent the leakage current flowing between the motherboard and the power supplies A or B. Moreover, because the Body Diode, the current is restricted to flow from the power supplies A or B to the motherboard. That is, no current can flow to the power supply A if power supply A is off but power supply B is on, or no current can flow to the power supply B if power supply A is on but power supply B is off. Moreover, to guarantee both the MOSFETs (PQ1, PQ2) can be connected by the control signal (C) no matter the input terminal (Si) is inputted by any specific voltages (+3V, +5V, and +12V), a voltage booster, for boosting the Stand-By-Power of +5VSB to a Stand-By-Power of +24VSB, is introduced in the detect circuit 210. That is, the control signal (C) is boosted to a Stand-By-Power of +24VSB that is relative high than any other specific voltages (+3V, +5V, and +12V). The voltage booster will not be discussed in detail due to the voltage booster is a well-known circuit applied widely in lots of control circuits.

For more understanding the function of the switch circuit adopted in the present invention, a transmitting process of a voltage power of +5V outputted from a power supply to the motherboard via the switch circuit is took as an example. Please refer to FIG. 5 again. The input terminal (Si) of the switch 200 receives +5V that is outputted from the power supply side and the output terminal (So) of the switch 200 is connected to the 24-pin plug 82 (FIG. 3).

As described above, the two detect terminals (D1, D2) are connected to the input terminal (Si) and the output terminal (So) of the switch 200, respectively. When the voltage at the detect terminal (D1) is greater than the voltage at the detect terminal (D2), the control signal at a high level (+24VSB) for the connection of the switch 200 is outputted from the detect circuit 210. Accordingly, the voltage power of +5V originally outputted from the power supply side can be transmitted to the 24-pin jack 82 (FIG. 3). On the other hand, if the voltage at the detect terminal (D1) is not greater than the voltage at the detect terminal (D2), the control signal at a low level for the disconnection of the switch 200 is outputted from the detect circuit 210. Accordingly, the voltage power of +5V cannot be transmitted to the 24-pin jack 82 (FIG. 3).

To sum up, the Power-Switch-On Signal (PSON), for activating the power supplies A and B, is firstly outputted from the motherboard after user pushing the power button of the computer. Then, all the specific voltages (+3V, +5V, and +12V) are started to build by the power supply A and B, and then outputted to the pin sets of the power supply A and B. Because the increasing of the specific voltages (+3V, +5V, and +12V), the voltage at the detect terminal (D1) must be greater than the voltage at the detect terminal (D2), so as the control signal at a high level for the connected of the switch circuit is outputted from the detect circuit 210, accordingly all the switch circuits in the power translating board are connected. Then, all the specific voltages (+3V, +5V, and +12V), from both the power supplies A and B, are transmitted to the motherboard. Moreover, after all the specific voltages (+3V, +5V, and +12V) are completely built and the power supplies A and B are at the stable state, the Power Good Signal (PG-A) of the power supply A (or, the Power Good Signal (PG-B) of the power supply B) is outputted to the motherboard, then the motherboard is aware of the power supply system is at a stable state.

Moreover, if one of the power supply (e.g., power supply A) in the power supply system of the present invention is damaged and cannot normally output the voltage power of +5V (e.g., can only output +1.5V), the switch circuit SW-A1 accordingly is disconnected due to the voltage at the power supply A side (+1.5V) is less than the voltage (+5V) at the 24-pin plug 82 side (FIG. 3), where the source of the voltage at the 24-pin plug 82 side is from the power supply B. It follows the voltage power outputted from the power supply A (e.g., +1.5V) cannot flow to the motherboard via the disconnected switch circuit SW-A1, and accordingly all the voltage power of +5V inputted to the motherboard is from the power supply B. In other words, the motherboard still can get +5V from the power supply B even the power supply A is damaged. Similarly, the motherboard still can get all other specific voltages (+3V and +12V) if either power supplies A or B is damaged.

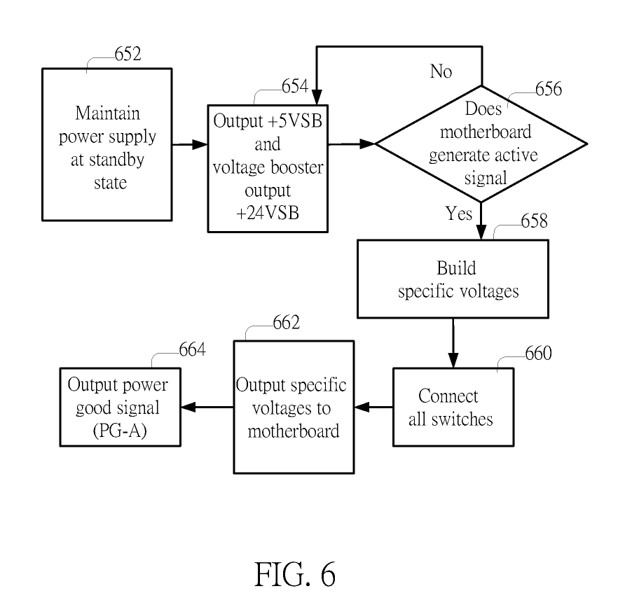

Referring to FIG. 6, a flowchart of the present invention is shown (only power supply A is introduced in the flowchart). Before the power button of the computer is pressed, the power supply is maintained at the stand-by state initially (step 652). When the power supply is at the stand-by state, only the +5VSB is outputted to the motherboard; moreover, the +5VSB is also boosted to the +24VSB by the voltage booster in the detect circuit (step 654). In step 656, the flowchart will move back to step 654 if the Power-Switch-On Signal (PSON) is not outputted from the motherboard (or the power button of the computer is not pressed). Alternatively, the flowchart moves to step 658 if the Power-Switch-On Signal (PSON) is outputted from the motherboard (or the power button of the computer is pressed).

After the Power-Switch-On Signal (PSON) is outputted from the motherboard to the power supply, the power supply is active and then the power supply starts to build the specific voltages (+3V, +5V, +12V) (step 658). In the processes of building the specific voltages (+3V, +5V, +12V), the voltage at the input terminal (Si) is greater than the voltage at the output terminal (So) in all switches, so as the switches in the power translating board are controlled to be connected (step 660). Afterwards, all the specific voltages (+3V, +5V, +12V) are further transmitted to the motherboard via the connected switches (step 662). The above-mentioned steps 658, 660, and 662 can be regarded as happening simultaneously.

Afterwards, the Power Good Signal (PG-A) is outputted to the motherboard after the specific voltages (+3V, +5V, +12V) are completely built and the power supply A is at the stable state.

To sum up, via the power translating board in the power supply system of the present invention, the motherboard always can get all the necessary specific voltages even one of the two power supplies is damaged. Moreover, based on the two MOSFETs (PQ1, PQ2) structured in back-to-back, all the currents are guaranteed to flow from the power supplies to the motherboard and no leakage currents can flow between the power supply and the motherboard.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply system adopting two power supplies connected in parallel, comprising:
a first power supply comprising a first voltage-output terminal;
a second power supply comprising a second voltage-output terminal;
a first switch circuit comprising an input terminal connected to the first voltage-output terminal;
a second switch circuit comprising an input terminal connected to the second voltage-output terminal; and
a plug comprising a first pin connected to both an output terminal of the first switch circuit and an output terminal of the second switch circuit;
wherein the voltage outputted from the first voltage-output terminal is equal to the voltage outputted from the second voltage-output terminal.

2. The power supply system adopting two power supplies connected in parallel according to claim 1 wherein the plug further comprises a second pin, and an active signal outputted from a motherboard is transmitted to the first power supply and the second power supply via the second pin.

3. The power supply system adopting two power supplies connected in parallel according to claim 1 further comprising a logic gate having a first input terminal connected to the first power supply, a second input terminal connected to the second power supply, and an output terminal connected to a third pin of the plug.

4. The power supply system adopting two power supplies connected in parallel according to claim 1 wherein the voltage outputted from the first voltage-output terminal is +3V, +5V, +5VSB, or +12V.

5. The power supply system adopting two power supplies connected in parallel according to claim 1 wherein the plug is a 24-pin plug, a 4-pin plug, a VGA plug, or a HD plug.

6. The power supply system adopting two power supplies connected in parallel according to claim 1 wherein the first switch circuit and the second switch circuit are arranged on a power translating board.

7. The power supply system adopting two power supplies connected in parallel according to claim 1 wherein the first switch circuit further comprises:
a switch comprising an input terminal being the input terminal of the first switch circuit, an output terminal being the output terminal of the first switch circuit, and a control terminal; and
a detect circuit comprising a first detect terminal connected to the input terminal of the first switch circuit and a second detect terminal connected to the output terminal of the first switch circuit, wherein a control signal is outputted from the detect circuit to the control terminal of the switch;
wherein the switch is connected if the voltage at the first detect terminal is greater than the voltage at the second detect terminal; or the switch is disconnected if the voltage at the first detect terminal is not greater than the voltage at the second detect terminal.

8. The power supply system adopting two power supplies connected in parallel according to claim 7 wherein the voltage of the control signal is greater than the voltage at the first voltage-output terminal.

9. A computer with a power supply system adopting two power supplies connected in parallel, comprising:
a first power supply comprising a first voltage-output terminal;
a second power supply comprising a second voltage-output terminal;
a first switch circuit comprising an input terminal connected to the first voltage-output terminal;
a second switch circuit comprising an input terminal connected to the second voltage-output terminal;
a plug comprising a first pin connected to both an output terminal of the first switch circuit and an output terminal of the second switch circuit; and
a motherboard comprising a jack disposed therein a first pin connected to the first pin of the plug;
wherein the voltage outputted from the first voltage-output terminal is equal to the voltage outputted from the second voltage-output terminal.

10. The computer with a power supply system adopting two power supplies connected in parallel according to claim 9 wherein the plug further comprises a second pin connected to a second pin of the jack, and an active signal outputted from the motherboard is transmitted to the first power supply and the second power supply via the second pin.

11. The computer with a power supply system adopting two power supplies connected in parallel according to claim 9 further comprising a logic gate having a first input terminal connected to the first power supply, a second input terminal connected to the second power supply, and an output terminal, connected to a third pin of the plug.

12. The computer with a power supply system adopting two power supplies connected in parallel according to claim 9 wherein the voltage outputted from the first voltage-output terminal is +3V, +5V, +5VSB, or +12V.

13. The computer with a power supply system adopting two power supplies connected in parallel according to claim 9 wherein the plug is a 24-pin plug, a 4-pin plug, a VGA plug, or a HD plug.

14. The computer with a power supply system adopting two power supplies connected in parallel according to claim 9 wherein the first switch circuit and the second switch circuit are arranged on a power translating board.

15. The computer with a power supply system adopting two power supplies connected in parallel according to claim 9 wherein the first switch circuit further comprises:
a switch comprising an input terminal being the input terminal of the first switch circuit, an output terminal being the output terminal of the first switch circuit, and a control terminal; and
a detect circuit comprising a first detect terminal connected to the input terminal of the first switch circuit and a second detect terminal connected to the output terminal of the first switch circuit, wherein a control signal is outputted from the detect circuit to the control terminal of the switch;
wherein the switch is connected if the voltage at the first detect terminal is greater than the voltage at the second detect terminal; or the switch is disconnected if the voltage at the first detect terminal is not greater than the voltage at the second detect terminal.

16. The computer with a power supply system adopting two power supplies connected in parallel according to claim 15 wherein the voltage of the control signal is greater than the voltage at the first voltage-output terminal.

17. A power supplying control method of a computer system for use with a first power supply and a second power supply both providing a first voltage to a motherboard, comprising steps of:
detecting whether the first power supply starts to build the first voltage;
outputting the first voltage, built by the first power supply, to a first pin when the first power supply starts to build the first voltage;
detecting whether the second power supply starts to build the first voltage;
outputting the first voltage, built by the second power supply, to the first pin when the second power supply starts to build the first voltage; and
outputting the first voltage power to the motherboard via the first pin.

18. The method according to claim 17 wherein the first power supply and the second power supply start to the build the first voltage after receiving an active signal from the motherboard.

19. The method according to claim 17 further comprising a step of outputting a power good signal to the motherboard after either the first power supply or the second power supply is at a stable state.
